(19) United States
(12) Patent Application Publication
(10) Pub. No.: US 2013/0339430 A1
(43) Pub. Date: Dec. 19, 2013

(54) Fears Online Interface 18

(71) Applicant: Gregory Vann Fears, Arlington, TX (US)

(72) Inventor: Gregory Vann Fears, Arlington, TX (US)

(21) Appl. No.: 13/452,445

(22) Filed: Jun. 18, 2012

(51) Int. Cl. H04L 29/06

(52) U.S. Cl. CPC H04L 65/403
USPC 709/204

(57) ABSTRACT

The Fears Online Interface 18 (OI 18) is the industries' first audio recording interface with online and wireless Internet capabilities. May be used for connecting your studio online with multiple OI 18's to record, collaborate, rehearse, and exchange recording session audio from their location into your professional DAW. The body is a 2space rack unit with 8 analog in/outputs, and 10 digital totaling 18inputs/18outputs. The OI 18 has a unique LCD screen per analog channel on front of the hardware, which displays the musician's name, state, instrument, and signal-bridge. Software 1.0 is a plug-in & standalone, providing the ability to organize your online cliental through an instant messenger type database, visibly interact, and drag and drop their recording screen name, into the desired recording input I/O, for an immediate collaborate session as the interface dials online and connect to the corresponding location.

### OBJECTIVE Bringing singers and musicians together across the world into a private or open recording session without leaving their homes, or studio.

### BACKGROUND OF THE INVENTION

This Invention relates to the recording music industry of pro audio interfaces, and more specifically, conducts a method of busing (transmitting and receiving) professional audio signals via Internet to connect musicians, songwriters, and aspiring artist all across the global nation simultaneously into the same recording session.

The body of this invention is a 2space rack unit (audio terms), with 8 analog XLR/TRS analog in preamps/8quarter inch line outputs. The Optical adat in/out, gives you an additional 8 channels of digital signals, and the spidif digital in/out, gives you two more digitals channels. This is the reason 18, is included in the name of this invention (OI18). Other included specs include: Midi in/out, 25db pad, Freq Response, 20 Hz-20 kHz, Dual fire wire 4 pin, and 6 pin (daisy chaining) , Dual Ethernet ports and wireless modem capability (Online connectivity), Phone Jack (optional form of modem connectivity), 8 independent 2×1 in, flashing LCD screens in front of device, Displays state, musician's screen name, and instrument, Supports sample rates 44.1 to 96, Compatible with Core Audio, Asio, MME, WDM, and multi-client drivers.

This 2space rack unit, will connect Ethernet, and/or wireless, allowing this apparatus to receive and send signals to and from any location in the world, and actively engage and involve others simultaneously even though they are not present in the same room, they will be in the same online studio recorded session.

### FEATURES AND SPECIFICATIONS

The Fears OI 18 also comes with a corresponding software plug-in application. Allows online connectivity linking your interface to fellow musician interfaces anywhere in the world, collaborate, practice, and record in their very recording session online. 2. Multiple online musicians record simultaneously, by choosing from contact list and routing you to desired I/O input recording path. 3.Video Instant messaging, allows you to view and/or chat with your musician cliental collaborating in your session. 4. Time log keeps track and record of online studio session blocks, and calendar and schedule keeps track of and reminds you of scheduled sessions. 5. 1.0 Interacts with interface to display name of musician, instrument, and state on LCD screen of interface. 6. Online hard drive option authorizes engineer of session to send & store recorded data. 7. Drag and drop offer ability to drag and drop musicians from buddy list to desired input I/O. 8. Bank draft feature debits bank or credit card online if necessary for studio time. 9. MTC connectivity to give multiple engineers control of online session. 10. Plug-in support extends and make present the OI 18's input and output connectivity in your DAW's I/O routing path once connected online. 11. Collaboration mode connects Online interfaces as standalone (collaboration/ interaction, but no recording).

### RELEVENCE ADVANTAGE OF INVENTION

Like myself, many music producers have musician friends all across the world. We send each other tracks to perform a designated instrument part to, or for example, lay down the bass part for specific songs based for an on going system of trial and error.

No doubt these musicians are talented, but there comes a time in every producers life where he needs to sit in on a session, with certain musicians, and vocalist working for hire.

One draw back to the recording industry today is many busy professional musicians (on the road), find it hard to maintain a balance to perform all over the world, and yet still fly across the country to record their instrument parts. They become emotionally drained and their families suffer.

On the other hand on the road or at home they have time to log on to check their emails, and MySpace pages. Another drawback is the amount of idle time spent recording these professional albums. With access time spent waiting on all band members, singers, engineers, songwriters, and vocal coaches to fly to a neutral location, the Fears OI 18 will be the perfect solution for this. It allows you from your home, professional, or mobile studio to connect online, select you musician associate (musician's buddy list) and upon connection, directly buss the signal of their voice/instrument from their OI 18 into your OI 18, then out into your recording DAW of preference, making it compatible for any and all platforms.

Finally everyone with talents and gifts is not blessed with the funds to fly these industry big wigs in from all over the nation to participate in the sessions, and fund the enormous studio block time it takes to complete a project. In simplest form, having the OI 18 and it's functions, is as simple as calling from one studio to the other, and recording the instrument/vocal signals from that location to yours while able to view your participants with the web cam feature. Clearly you see there is a great need for everyone in music to require this interface as a movement of the future, making it effortless to connect artists, musicians, and singers together from all over the world into private, or open simultaneous online recording sessions, in the comfort of there own homes!

### SUMMARY OF THE INVENTION

This invention breaks barriers in professional audio recording, by allowing others to connect to the Fears OI18 recording interface, and involve up to 18 other online corresponding users of the OI18's online network, to record in the same studio session in real-time regardless of their location.

The reference claims, features, and advantage of this current invention, will be further explained and understood, in my claims and future drawings.

### BRIEF DESCRIPTION OF DRAWINGS

FIG. 1. Illustrates the Rear view of the OI18, with an enlarged view displaying the features in almost actual sized.

FIG. 2. Illustrates the front view of the Fears OI 18, hardware-recording interface, according to the generalized idea of this invention.

FIG. 3a. Illustrates the signal flow, of a musical audio source, plugged into the OI 18 interface, as it routes and give explanation of where the signal is going, and where it will be recorded.

### DETAILED DESCRIPTION OF DRAWINGS

Represented in the following drawings are the spec features, and components necessary to construct a prototype of the OI 18. These are by no means to be limited to the exact formality of the drawings, as they are rough draft to the construction of this design and features.

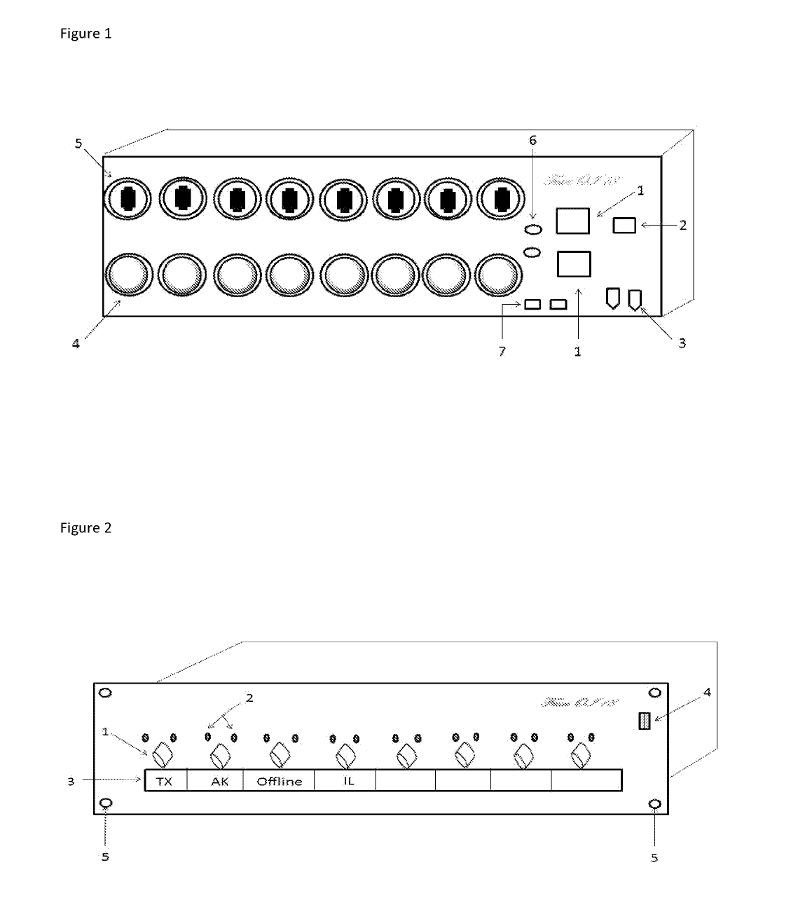

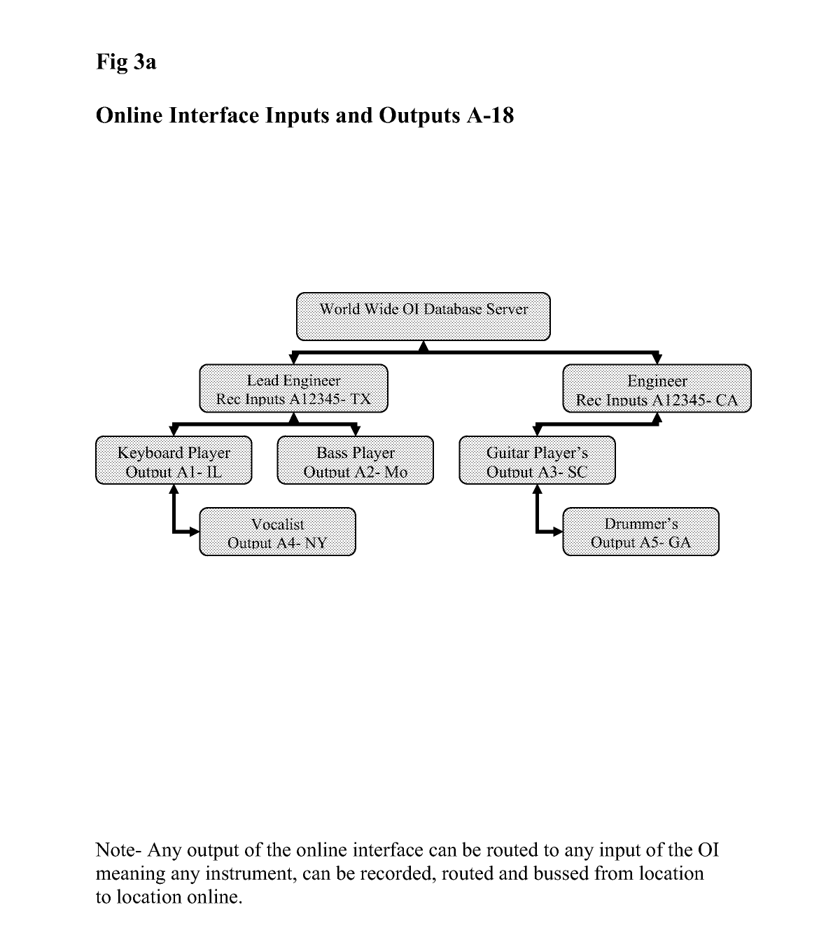

Referring to FIG. 1), is the rear view with an enlarged view of the analog inputs, and different features, connections, and ports with a basic template of how to design this section. The rear is constructed of a square box frame, made of metal with the following ports and connections. (1) Is referring to the dual square Ethernet ports. This port is also a claim*. This port when connected, brings Internet connectivity, and activates your interface and plug-in software (making it connect and available online). It also, activates the wireless modem within allow it to connect online wireless. When the Ethernet is connected, your (previously normal) audio interface that sends your audio, from your instruments through your interface to your recording program on your computer, now becomes like an IP address, with available routing to another OI18 allowing each person connected to hear the audio routed as if they were present in your studio. This specific port is the whole motivation behind this extremely beneficial idea. (2) Is also a claim *, allowing for this specific invention to update technology and allows the phone jack connectivity, in which a dial up Internet is possible, as well as a telephone line or fax machine. Making your home studio suitable to be your office as well, all connecting through your audio recording interface. (3) Represents the 1394 Fire-wire port. Its pretty self-explanatory, It connects your interface to your computer via fire-wire. (4) Represents the TRS ¼ output. This port actually sends your audio of a specific channel out to another interfaces' input. The cable connection required is a standard ¼ guitar or instrument line cable. You have (5) Is referring to the XLR/TRS ¼ port. This port allows connectivity from a instrument line, such as a guitar chord, or a microphone. These ports are considered inputs labeled 1-8. Further describing these ports, 1-8 is basically saying up to 8 instruments or microphones at a time in these ports. Example, so if 8 instruments are simultaneously recording, with the degree of this invention, they are now allowed into your recording session from anywhere in the world. (6) Is referring to 2 digital spidif ports, in which 2 RCA type spidif cables, is the cord connection, allowing 2 more additional digital audio in/outputs. (7) Describes the adat light-pipe port, In which the adat connectivity allows for 8 more additional digital input/outputs. This port does not use the average instrument guitar cable, but instead connects an extensional microphone pre interface via adat, in which you can plug your instrument in the adat interface, and route those additional digital inputs/outs in your I/O session. To further explain 8 in/outs, plus 2 spidif digital, plus 8 digital adat=18 in/outputs which is where the Fears OI 18 gets the digit part of it's name.

Referencing (FIG. 2). This is the front of the 2space rack interface. It's constructed of a metal faceplate which is about 6 in wide, and 12 in long. It has 8 knobs, which can be made of firm plastic, with a line on front to identify the clock position and degree, for the finger turning knob. (1) This knob represents the controlling of the volume ± per audio channel determining volume levels of the individual 8 audio input signal channel. These knobs rotate in a circular motion 360′ degrees. On top of each knob are two tiny buttons, horizontal right and left and are millimeters apart. (2) These are push in/out buttons. The left button represents 48v phantom power. This button pushed in, sends phantom power to microphones that won't cut on or operate with out the extra power, which is most of the high-end microphones. The right button represents the pad button. It's a push in/out button as well. The pad button pushed in immediately elevates the audio signal on the channel louder by about 10 db's. With the button pushed out it vise versa deceases the signal by −10 db's. Below the buttons (1) are 8 individual LCD screens (3) approximately lin wide, which displays and flashes the location city, name of musician, instrument, and volume level of connected (OI 18), for that channel. Also flashes offline status if nothing is connected. (4) A power button in the upper right corner of front plate, also with 1 drilled hole per corner (5), designed to tighten and mount in the stationary rack-mounting unit.

1. A professional recording audio interface Fears OI 18, equipped with the world wide connectivity to bus and route audio signal path to and from any location in the world, to your input/output I/O's in your recording program platform.

2. This also allows the process of signal flow routing and bussing any I/O combination from the connected online interfaces' to any available input on your Fears OI 18 regardless of your world wide location, and any other recording DAW interface looking to expand to online routing and capabilities.

3. Live musicians and singers recording simultaneously from out of the country, connecting through a recording online interface.

4. I also claim the attachment of an Ethernet port, or dual Ethernet ports to the fire-wire and usb recording interface.

5. Recording fire-wire/usb interface with wireless Internet capabilities/airport connectivity.

6. Process to establish Wi-Fi connection for online collaboration, simultaneous recording from any location in the world, from the recording interface

7. Fire-wire/usb recording interface, with installed modem

8. The recording interface with added phone jack connectivity, allowing a dial up connectivity, telephone line to connect through the recording interface as well fax machine.

9. Recording interface fire-wire/usb, connects online and establishes IP Address with server.

10. Mini LCD screens, which visibly flash the display I/O of input and output information, Musicians, screen name, world location, and volume db level. It corresponds the visible display of the routed connections from other online interfaces throughout the world.

11. I claim the plug-in software 1.0 synching recording interface to the plug-in software.

12. The procedure for a recording interface to correspond with vst plug-in software (OI 18 1.0), which is a DAW for beginners, a stand alone, and an expansion as online connectivity to existing professional recording DAW, which provides the following features:
(A) Allows real-time visibility (webcam)
(B) Interacting collaboration online
(C) Exchanging of music file data
(D) Studio time logs
(E) Scheduling management
(F) Client contact list organization
(G) Bank option for making applicable payment transfers
(H) Musician's messenger (instant messenger)
(I) Drag and drop feature from contact list to destination input or output.
(J) VST support, versatile to connect and expand to your existing DAW Standalone version offers recording and collaborating w/o previous existing recording DAW.
